(19) United States
(12) Patent Application Publication
(10) Pub. No.: US 2023/0405378 A1
(43) Pub. Date: Dec. 21, 2023

(54) PRESSURISED CONTAINER

(71) Applicant: ARDENT LIMITED, Roecliffe, Boroughbridge North Yorkshire (GB)

(72) Inventors: Matthew MALEWSKI, Roecliffe (GB); Jackie CHAN, Roecliffe (GB)

(21) Appl. No.: 18/249,662

(22) PCT Filed: Oct. 14, 2021
(86) PCT No.: PCT/GB2021/052663

§ 371 Date: Apr. 19, 2023

(30) Foreign Application Priority Data
Oct. 21, 2020 (GB) 2016704.5

(51) Int. Cl. A62C 13/76; A62C 13/64

(52) U.S. Cl. CPC A62C 13/76; A62C 13/64

(57) ABSTRACT

A fire suppression apparatus (1000) comprises an enclosed hollow cylinder (1100) for containing a firefighting agent (not shown). The cylinder (1100) has a cylindrical side wall (1110) and upper and lower dome-ends (1120) and (1130), respectively. The lower end (1130) features supporting feet (1132). At the upper end (1120), an outlet valve (1122) is mounted on a neck-ring (1123) of the cylinder. The valve (1122) comprises an inlet connected to a dip-tube 1200 having a venturi device (1300). The valve itself comprises an outlet (1124). A nozzle, or distribution network to nozzle(s), (not shown) may be attached to threaded stub (1126) to direct firefighting agent during discharge.

The present invention relates to containers for containing a material that is ejected by a pressurised gas, and more particularly, although not exclusively, with such containers when used in fire suppression systems.

A known pressurised container, which may typically comprise a cylinder, contains an agent such as gas, liquid or powder, under pressure. The cylinder is pressurised by an expellant gas, which is typically nitrogen or carbon dioxide. Release of the contents is controlled by an outlet valve mounted on a neck-ring of the cylinder, typically at the top in the vertical orientation. When the valve is opened, the pressure inside the cylinder forces the agent out of the cylinder.

The agent may typically be a liquid, a powder, a gas or some combination thereof.

A tube, known as a “dip tube” is in fluidic communication with the valve and extends towards the lowest point of the cylinder when upright to help to capture even low levels of agent during discharge. However, the yield of this kind of container is rarely 100%, there being always a residual quantity of agent left in the cylinder due to the dip-tube terminating above the lowest point of the cylinder, as well as the progressively reduced pressure and flow rates of the propellant gas, which is wasteful.

Common examples of these apparatus include fire suppressant apparatus, for example for use in buildings or vehicles, in which the agent is a fire suppressant agent. When fighting a fire, low yields of suppressant can hinder a fire suppression operation.

Embodiments of the present invention aim to provide a fire suppressant apparatus in which the aforementioned disadvantages are at least partly addressed.

The present invention is defined in the attached independent claims, to which reference should now be made. Further, preferred features may be found in the sub-claims appended thereto.

According to one aspect of the present invention, there is provided a container for containing a dischargeable agent under pressure, the container comprising a discharge conduit through which the agent is arranged to pass during discharge under the influence of a pressurised gas, and wherein part of the discharge conduit comprises a venturi device.

The container preferably comprises a pressurised fire suppressing apparatus for containing a firefighting agent.

The venturi device of the discharge conduit may be located inside the container. Preferably, the venturi device is located upstream of a valve or adaptor of the container.

More preferably, the venturi device is located at, or adjacent, an inlet of the valve or adaptor.

The venturi device may comprise a main pathway for the passage of the agent during discharge.

Preferably, at least one aerator duct extends into the discharge conduit from an interior space of the container. More preferably, at least one aerator duct extends through a wall of the venturi device to fluidically connect an interior of the venturi device with an interior space of the container.

The venturi device may define a flow axis and preferably comprises an entry stage, with respect to a flow direction of an agent during discharge. The venturi device preferably includes a throat part. The venturi device preferably includes an exit part with respect to a flow direction of an agent during discharge. In a preferred arrangement, the entry stage and/or the exit stage includes a wide end and a narrow end, wherein the wide end has a greater cross-sectional area than the narrow end, with respect to the flow axis. The entry stage and/or the exit stage are preferably substantially frusto-conical in shape. In a preferred arrangement, the entry stage is shaped so that its cross-sectional area decreases in the direction of flow. The exit stage is preferably shaped so that its cross-sectional area increases in the direction of flow.

The throat stage is preferably located between the entry stage and the exit stage and is preferably integrally connected to both. In a preferred arrangement, the throat stage has a cross sectional area that is substantially the same as the entry stage at the point at which the two meet.

The throat stage preferably has a cross sectional area that is substantially the same as the exit stage at the point at which the two meet.

The throat stage preferably has a substantially constant cross-sectional area and is more preferably cylindrical.

At least one aerator duct may be provided which extends between an interior of the throat and an interior volume of the container. At least one aerator duct may extend between an interior of the entry stage and an interior volume of the container. At least one aerator duct may extend between an interior of the exit stage and an interior volume of the container.

In a preferred arrangement, the entry stage and/or throat stage and/or exit stage and/or aerator duct are integrally formed from a single piece, more preferably of metal, such as brass or stainless steel.

According to another aspect of the present invention, there is provided a method of discharging an agent from a container containing the agent under the action of a pressurised expellant gas, the method comprising directing the agent through a discharge conduit comprising a venturi device within the container.

Preferably the method comprises discharging a firefighting agent from the container.

The method preferably comprises aerating the agent as it passes through the venturi device using fluid flowing from an interior of the container into the venturi device through an aerator duct extending from the interior of the venturi device to an interior volume of the container.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

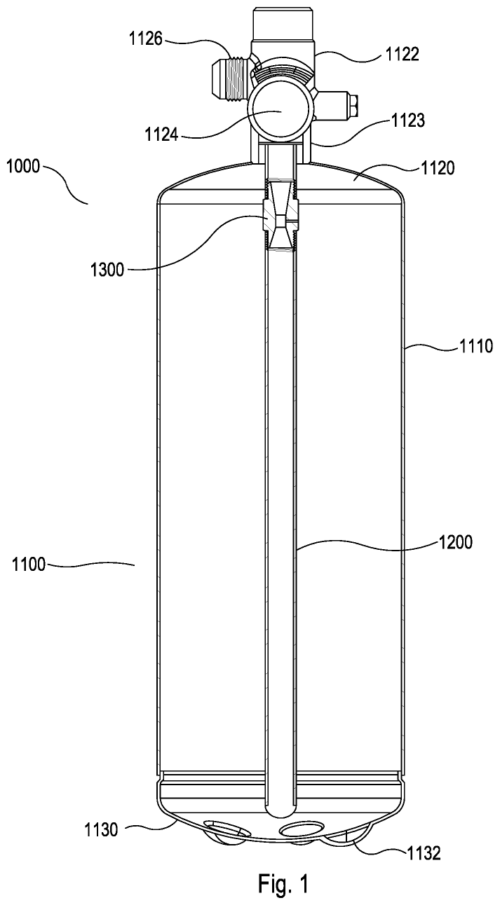

FIG. 1 shows, in part sectional view, a fire suppression apparatus in the form of a cylinder, being in accordance with an embodiment of the present invention;

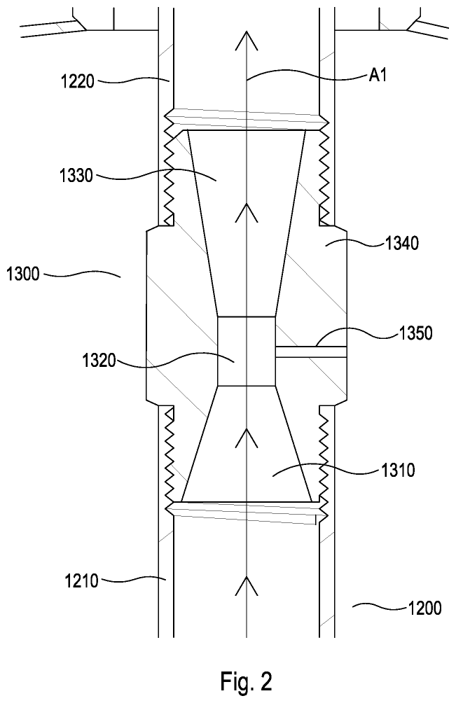

FIG. 2 is a more detailed view of part of the apparatus of FIG. 1;

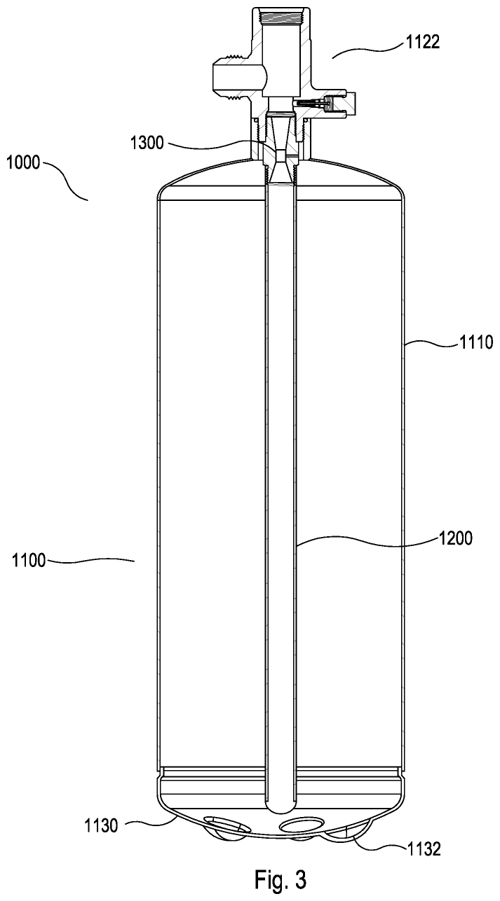

FIG. 3 shows a fire suppression apparatus in accordance with an alternative embodiment of the present invention; and

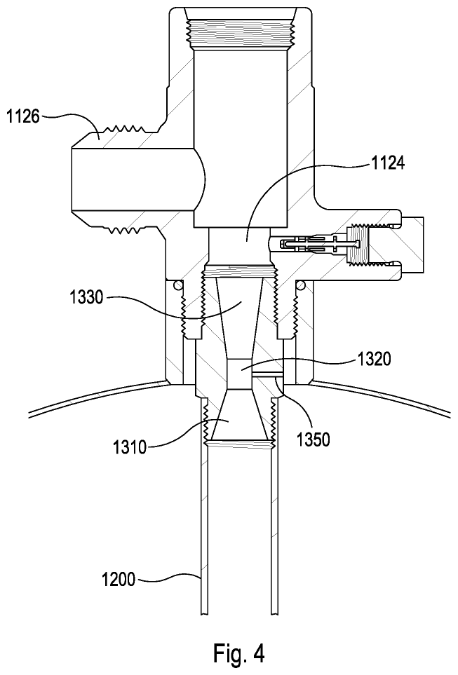

FIG. 4 is a more detailed view of a part of the apparatus of FIG. 3.

Turning to FIG. 1, this shows, in part sectional view, generally at 1000, a fire suppression apparatus comprising an enclosed hollow cylinder 1100 for containing a firefighting agent (not shown) and an expellant gas under pressure. The cylinder 1100 has a cylindrical side wall 1110 and upper and lower dome-ends 1120 and 1130, respectively. The lower end 1130 features supporting feet 1132. At the upper end 1120, an outlet valve 1122 is mounted on a neck-ring 1123 of the cylinder. The valve 1122 comprises an inlet connected to a dip-tube 1200 having a venturi device 1300. The valve itself comprises an outlet 1124. A nozzle, or distribution network to nozzle(s), (not shown) may be attached to threaded stub 1126 to direct firefighting agent during discharge.

Inside the cylinder, in fluidic communication with the outlet, the dip tube 1200 extends substantially along a longitudinal axis of the cylinder towards the lower end 1130 thereof. The venturi device 1300 is located close to the upper end 1120, which will be described below with reference to FIG. 2.

FIG. 2 is an enlarged view of the venturi device 1300 of FIG. 1. The venturi device 1300 comprises a frusto-conical convergent entry stage 1310, a cylindrical throat stage 1320 and a frusto-conical divergent exit stage 1330 all within a machined body 1340. The venturi device 1300 is threadedly connected in-line with the dip tube 1200 between an inlet run portion 1210 and an outlet run portion 1220 thereof.

Arrow A1 shows the direction of flow of firefighting agent during discharge.

An aerator duct 1350 extends between the throat stage 1320 and the exterior of the venturi device 1300—i.e. into the surrounding volume of the cylinder 1110.

When the outlet valve is opened, the consequent reduction in pressure in the dip tube causes the expellant gas to force the firefighting agent up the dip tube and ultimately through of the outlet valve. However, due to the Venturi Effect, when the agent flows through the venturi device 1300 the pressure there is further reduced whilst the velocity increases. This assists in drawing up agent from the bottom of the cylinder which might otherwise remain there as the expellant gas becomes exhausted. In this way, the yield of the apparatus is improved.

Furthermore, the aerator duct 1350 introduces a jet of expellant gas or (if below the fill level of agent) agent directly into the throat stage which disrupts the flow of agent through the venturi device. This is useful in a number of ways:

Where the agent is a liquid with a foaming component, the aeration jet agitates the liquid to improve the foaming process.

Where the agent is a liquid or liquified gas having a low vapour pressure, such as a halogenated compound, the aeration jet reduces the concentration of the agent allowing higher ratios of vapour-liquid phases due to the increased mixing with expellant gas reducing the proportion of the agent that becomes a gas prior to it reaching the nozzle. Furthermore, due to the pressure drop as a result of the venturi effect, the device promotes the transition of liquid to vapour.

Where the agent is a powder, the aeration jet promotes a more homogenous mixture of propellant and agent, whilst also increasing the momentum of the powder.

FIGS. 3 and 4 show an alternative embodiment of the present invention in which the venturi device 1300 is located partly within the valve assembly 1122, immediately before the valve 1124. In other respects, the device and its effect are substantially the same.

Embodiments of the invention promote increased yield of firefighting apparatus and can be used either with containers storing pressurised expellant gas therein as well as those using a cartridge to deliver the expellant. There are additional advantages provided by the aerator duct or ducts which improve the combination of expellant gas and agent, and hence the discharge process.

The venturi device may be used as an in-line component in the dip tube or else may be fitted—or designed into—the outlet valve or outlet adaptor. The ratio of the throat stage diameter to the diameter of the entry and/or exit stages of the venturi device and/or to the diameter of the dip tube itself, and indeed the ratio of the inlet and outlet run portions of the dip tube, may be chosen according to the type of agent being discharged. Depending on the characteristics desired, the aerator duct or ducts may be incorporated into the inlet run of the dip tube, the entry, throat or exit stages of the venturi device or the outlet run of the dip tube, or indeed a combination of these.

The aerator duct may be placed above or below the fill-level of the agent, depending on the desired flow characteristics. The cross-sectional area of the aerator duct may also be varied accordingly. Furthermore, the angle of convergence/divergence of the entry and exit stages of the venturi device may be selected according to desired performance.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A container for containing a dischargeable agent under pressure, the container comprising a discharge conduit through which agent is arranged to pass during discharge under the influence of a pressurised gas, wherein part of the dip-tube comprises a venturi device.

2. A container according to claim 1, wherein the container comprises a fire-suppressing apparatus for containing a firefighting agent.

3. A container according to claim 1, wherein the venturi device is located upstream of a valve or adaptor of the apparatus.

4. A container according to claim 1, wherein the venturi device comprises at least a part of a main pathway for the passage of the agent during discharge.

5. A container according to claim 1, wherein at least one aerator duct extends into the discharge conduit from an interior space of the container.

6. A container according to claim 5, wherein the aerator duct extends through a wall of the venturi device to fluidically connect an interior of the venturi device with the interior space of the container.

7. A container according to claim 1, wherein the venturi device defines a flow axis and comprises an entry stage with respect to a flow direction of agent during discharge.

8. A container according to claim 1 wherein the venturi device includes a throat part.

9. A container according to claim 1, wherein the venturi device includes an exit part with respect to a flow direction of agent during discharge.

10. A method of discharging an agent from a container containing the agent under the action of a pressurised expellant gas, the method comprising directing the agent through a discharge conduit comprising a venturi device within the container.

11. A method of discharging an agent from a container according to claim wherein the agent is a firefighting agent.

12. A method according to claim 10, wherein the method comprises aerating the agent as it passes through the venturi device using fluid flowing from an interior of the container into the venturi device through an aerator duct extending from the interior volume of the container into the discharge conduit.
